(19) United States
(12) Patent Application Publication
(10) Pub. No.: US 2015/0046971 A1
(43) Pub. Date: Feb. 12, 2015

(54) METHOD AND SYSTEM FOR ACCESS CONTROL IN CLOUD COMPUTING SERVICE

(71) Applicant: INTELLECTUAL DISCOVERY CO., LTD., Seoul (KR)

(72) Inventors: Eui Nam Huh, Seoul (KR); Sang Ho Na, Yongin-si (KR); Jun Young Park, Yongin-si (KR); Jin Taek Kim, Seoul (KR)

(73) Assignee: INTELLECTUAL DISCOVERY CO., LTD., Seoul (KR)

(21) Appl. No.: 14/345,188

(22) PCT Filed: Oct. 26, 2012
(86) PCT No.: PCT/KR2012/008855

§ 371 Date: Mar. 14, 2014

(30) Foreign Application Priority Data
Oct. 27, 2011 (KR) 10-2011-0110555

(51) Int. Cl. H04L 29/06

(52) U.S. Cl. CPC H04L 63/10; H04L 63/0853
USPC 726/1

(57) ABSTRACT

Provided is a method and system for assigning a suitable right to a user through a security policy based access control in a computing service. A collaborative service server may authenticate a user through a cloud service server, and may issue an access token including user authentication information and user right information. The cloud service server may compare information associated with the access token and an access control list and may determine whether to authorize an access of the user to the service based on the comparison result.

### TECHNICAL FIELD

The present invention relates to a cloud computing system, and more particularly, to a method and system for assigning a suitable right to a user through a security policy based access control in a cloud computing service

### BACKGROUND ART

Cloud computing refers to technology of providing a large scale of information technology (IT) resources using virtualization technology and distributed processing to technology. Using a cloud computing service, a user may be provided with a service with respect to computing resources through the Internet. Computing resources may include a memory resource, a central processing unit (CPU) resource, a network resource, a storage resource, and the like. The user may pay an entity operating the cloud computing service a fee corresponding to an amount of computing resources used by the user.

Specifically, cloud computing refers to technology of integrating, into a single computing resource through virtualization technology, computing resources that are present at physically different positions and providing the integrated computing resource to users. For example, cloud computing may be regarded as “Internet based and user centered on-demand outsourcing service technology”.

When the Internet is provided, the user may use a computing environment of the user through the cloud computing service without restrictions on a time and an occasion. The cloud computing service charges the user with a fee corresponding to an amount of resources used by the user. Also, through a computing environment of the cloud computing service, the user may be provided with all of the services such as a hardware service, a software service, an after service (AS), and the like. Accordingly, costs for maintaining and repairing a system may be reduced, costs for purchasing software may be reduced, and an amount of energy used for computing processing may be reduced.

With the increasing attention to the cloud computing service, the cloud computing service has been widely distributed under the lead of major IT companies. The cloud computing service includes four cloud computing service types, such as a public cloud service, a private cloud service, and the like.

The public cloud service may provide a cloud service to many and unspecified users through the Internet. The public cloud service indicates neither providing of a free service nor opening of data and a source associated with a service. The public cloud service may also provide a service using a user access control, charge, and the like. In the public cloud service, a service provider may manage user information and the resources of the cloud computing service may be shared. Accordingly, the public cloud service may have a weakness in protecting personal information of a user.

The private cloud service may provide the same computing environment as in to the public cloud service. The private cloud service indicates a cloud service that enables a predetermined company or institution to directly manage a cloud computing service, data, and process. Specifically, the private cloud service may be a closed cloud service type that avoids an external access and permits access of only authorized users for security.

A communication cloud service refers to a cloud computing service for a group of predetermined users. The communication cloud service may assign an access right only to members of a predetermined group. Members of a group may share data, an application, and the like through the communication cloud service.

A hybrid cloud service refers to a service in which the public cloud service and the private cloud service are combined. The hybrid cloud service may basically provide the public cloud service and may follow a policy of the private cloud service with respect to data and a service that a user does not desire to share.

A structure of the cloud computing service may be classified into an infra-type service structure, a platform-type service structure, and a software service structure. The infra-type service structure may provide a user-tailored computing environment based on requirements of a user. The platform-type service structure may provide an environment in which a user may select and use a platform suitable for a computing purpose of the user. The software service structure may provide an environment in which a user may select and use software suitable for a usage purpose.

In the cloud computing service, robust and systematic access control policy and authorization policy are required. Also, the personal cloud service provides a service through collaboration between different service providers. Accordingly, with respect to the personal cloud service, an access control method suitable for a characteristic of the personal cloud service may be required, and there is a need to provide a delegation and an authorization policy with respect to an access control. Also, there is a need for an access control method specified for the personal cloud service, compared to an existing access control method.

### DISCLOSURE OF INVENTION

### Technical Goals

An embodiment may provide an access control method and system for a personal cloud service.

An embodiment may also provide a method and system associated with an access control suitable for a characteristic of a personal cloud service providing a service through collaboration between different service providers, and may also provide a method and system associated with a delegation and an authorization policy.

### Technical Solutions

According to an aspect, there is provided a A collaborative service server of a cloud computing service, including: a user service list database to store right information of a user associated with a service subscribed to by the user and security policy information associated with the service; and an access token issuing unit to issue an access token of the service based on a service access request of the user, user authentication, and a service right.

The collaborative service server may perform the user authentication through a cloud service server.

The access token issuing unit may issue the access token based on a result of the user authentication provided from the cloud service server.

The user service list database may provide the right information and the security policy information to the cloud service server.

The access token may include information associated with the user authentication and the right information.

The user service list database may periodically update the right information and the security policy information.

In response to a request for a new service from the user, the user service list database may update the right information and the security policy information associated with the service subscribed to by the user.

According to another aspect, there is provided a cloud service server, including: a policy information unit to store a security policy associated with a service accessed by a user and user right information associated with the service; and a policy decision unit to compare information associated with an access token with an access control list, the security policy, and the user right information, and to authorize an access of the user to the service when information associated with the access token matches the access control list, the security policy, and the user right information as the comparison result.

The cloud service server may further include a policy administration unit to set to or correct a right of the user, a service policy, and a role.

When the right of the user, the service policy, or the role is set or corrected, the policy administration unit may transmit information associated with the set or corrected right of the user, service policy, or role to the collaborative service server.

According to still another aspect, there is provided a method of providing a collaborative service in a cloud computing service, the method including: storing, by a user service list database, right information of a user associated with a service subscribed to by the user and security policy information associated with the service; and issuing, by an access token issuing unit, an access token of the service based on a service access request of the user, user authentication, and a service right.

The collaborative service providing method may further include performing the user authentication through a cloud service server.

The issuing may include issuing the access token based on a result of the user authentication provided from the cloud service server.

The storing may include providing the right information and the security policy information to the cloud service server.

According to yet another aspect, there is provided a method of providing a cloud service, the method including: storing, by a policy information unit, a security policy associated with a service accessed by a user and user right information associated with the service; and comparing, by a policy decision unit, information associated with an access token with an access control list, the security policy, and the user right information, to authorize an access of the user to the service when information associated with the access token matches the access control list, the security policy, and the user right information as the comparison result.

The cloud service providing method may further include setting or correcting, by a policy administration unit, a right of the user, a service policy and a role.

The cloud service providing method may further include transmitting, by the policy administration unit, information associated with the set or corrected right of the user, service policy, or role to the collaborative service server when the right of the user, the service policy, or the role is set or corrected.

### Effect of the Invention

According to embodiments, there may be provided a method and system to associated with an access control suitable for a characteristic of a personal cloud service providing a service through collaboration between different service providers.

Also, according to embodiments, there may be provided a method and system associated with a delegation and an authorization policy.

### BRIEF DESCRIPTION OF DRAWINGS

FIG. 1 is a diagram illustrating a dataflow in extensible access control markup language (XACML);

FIG. 2 is a diagram illustrating a framework of an azure access control service;

FIG. 3 is a diagram illustrating a role based access control workflow;

FIG. 4 is a block diagram illustrating an access control system in a cloud computing service according to an embodiment;

FIG. 5 is a block diagram illustrating a configuration of a collaborative service server according to an embodiment;

FIG. 6 is a block diagram illustrating a configuration of a cloud service server according to an embodiment;

FIG. 7 is a block diagram illustrating an access control system in multiple cloud service servers according to an embodiment; and

FIG. 8 is a flowchart illustrating an access control method of a single cloud service server according to an embodiment.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

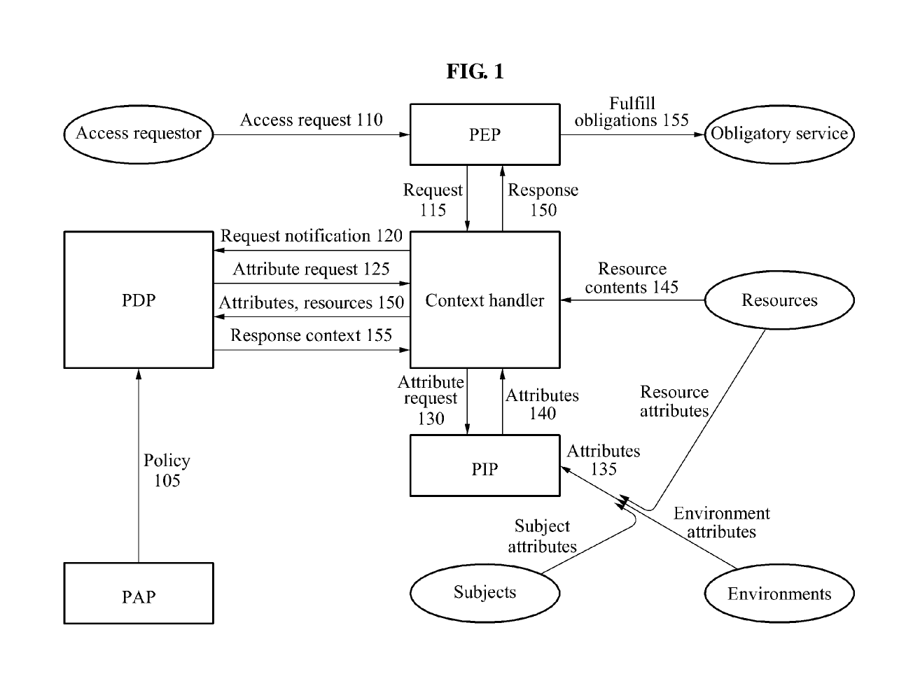

FIG. 1 is a diagram illustrating a dataflow in extensible access control markup language (XACML).

The XACML may be a standard to define a data structure for transferring security information such as authentication information and right information in a web environment.

An access control may include information for determining whether to permit a required access to a resource and information for execution of access decision. An access control policy may be a standard to determine the access control.

A key standard of the XACML may be defined by a grammar and a rule used to evaluate a permission policy. The XACML may be designed so that information used for access control may efficiently operate for an application that is managed by an automated entity.

In association with the XACML, an attribute may indicate an environmental characteristic that a subject, a resource, an action, a predicate, or a target may refer to.

A policy administration point (PAP) may be a system element to generate a policy or a policy set.

A policy decision point (PDP) may be a system element to evaluate an applicable policy and generate an authorization decision.

A policy enforcement point (PEP) may be a system element to perform an access control by generating a decision request and by performing the authorization decision.

A policy information point (PIP) may be a system element to function as a source of an attribute value.

Hereinafter, a dataflow of the XACML will be described with reference to FIG. 1.

In operation 105, PAP may write policies and policy sets. The PAP may provide the policies and the policy sets to a PDP so that the PDP may use the policies and the policy sets. The policies and the policy sets may represent a complete policy with respect to a specified target.

In operation 110, an access requestor may transmit an access request to a PEP.

In operation 115, the PEP may transmit the access request to a context handler in a native request format of the access request. Alternatively, the access request may include subjects, resources, actions, environments, and attributes of other categories.

In operation 120, the context handler may construct an XACML request context and may transmit the generated XACML request context to the PDP.

In operation 125, the PDP may request the context handler for an additional subject, resource, action, environment, and attributes of other categories.

In operation 130, the context handler may request a PIP for attributes.

In operation 135, the PIP may obtain the requested attributes. The requested attributes may include subject attributes, environment attributes, and resource attributes.

In operation 140, the PIP may return the requested attributes to the context handler.

Alternatively, in operation 145, the context handler may include a resource in a context.

In operation 150, the context handler may transmit the requested attributes to the PDP. Alternatively, the context handler may transmit resources to the PDP.

The PDP may evaluate a policy.

In operation 155, the PDP may transmit a response context to the context handler. The response context may include authorization decision.

In operation 160, the context handler may translate the response context to a native request format of the PEP. The context handler may return a response to the PEP.

In operation 165, the PEP may fulfill obligations.

When an access is permitted, the PEP may permit the access to the resource. Otherwise, the PEP may deny the access.

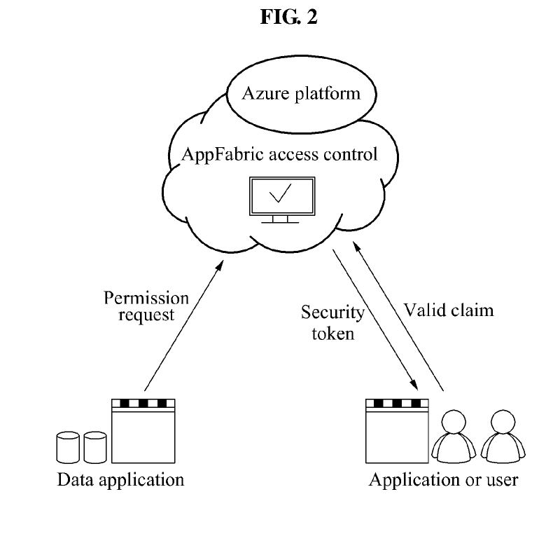

FIG. 2 is a diagram illustrating a framework of an azure access control service.

The azure access control service may issue a standard based token within a cloud. A token may be a multi-tenant capable of using a host or all of the accounts of AppFabric. The token may be a security token.

An access control service of “.NET” may provide a function that enables an authentication service and an authorization service to be manageable by an external security professional.

A security professional of “azure” may control authentication and token issuance. Therefore, an application may employ verification of a token for an authentication procedure.

AppFabric access control performed on an azure platform may receive a valid claim from an application or a user. The AppFabric access control may receive a permission request from a data application. The AppFabric access control may transmit the security token to the application or the user.

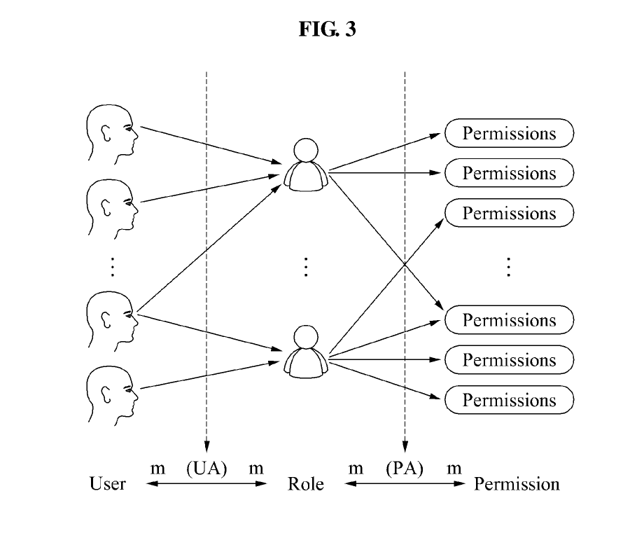

FIG. 3 is a diagram illustrating a role based access control (RBAC) workflow.

The RBAC may be a basic control for an access control in a personal cloud service. Referring to FIG. 3, each of users corresponds to at least one role. Each role corresponds to at least one permission. For example, each user may be assigned with predetermined roles, and each role may be assigned with predetermined permissions.

In a legacy control method, only a user holding the right to predetermined data or resource may access the predetermined data or resource.

A model according to the RBAC may be used for a healthcare field and the like. For example, in a general hospital, a role may be clearly classified for each user. Here, a user may be a doctor, a nurse, and a patient.

Authorization according to a user role may be determined by the RBAC, in place of a system manager.

Individual users may be clearly classified based on a duty of each user. Whether to authorize a service usage may vary for each user.

A role of a user and a right of the role may be constructed based on a many-to-many relationship.

The RBAC may provide various qualifications and may provide authorization for each group. On the other hand, the RBAC may not satisfy a data access and a service access considering a user right. Also, the RBAC may not satisfy identification of user profile information and a policy. Accordingly, a new access control method and system considering a cloud environment may be required.

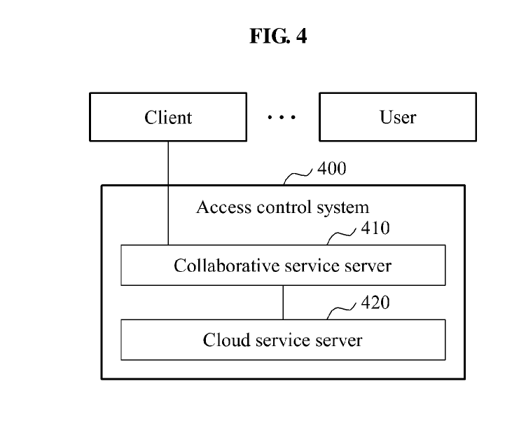

FIG. 4 is a block diagram illustrating an access control system in a cloud computing service according to an embodiment.

An access control system 400 may include a collaborative service server 410 and a cloud service server 420. The access control system 400 may be provided by a single cloud service provider. Another configuration in addition to the aforementioned configuration may be included in the access control system 400.

A client may indicate a terminal used by a user.

The cloud service server 420 may authenticate the user. To use a cloud computing service, the user may subscribe to the cloud service server 420 providing the cloud computing service to users. The user may enter a user identifier (ID), a user password, and user personal information into the cloud service server 420. The cloud service server 420 may issue an ID desired by the user to the user after user authentication.

The user may transmit a user authentication request to the collaborative service to server 410. The collaborative service server 410 enables the user authentication to be performed by the cloud service server 420 through redirection of the user authentication request. The cloud service server 420 may encrypt the user personal information and store the encrypted user personal information. The cloud service server 420 enables the user personal information to not remain in the cloud service server 420 through the encryption and storage.

To prevent the user personal information from remaining within the cloud service server 420, the collaborative service server 410 may request the cloud service server 420 for performing the user authentication through redirection.

When the user is authenticated, the collaborative service server 410 may issue an access token for an access of the user to a service based on a security policy of the cloud service server 420. The access token may include user authentication information and user right information.

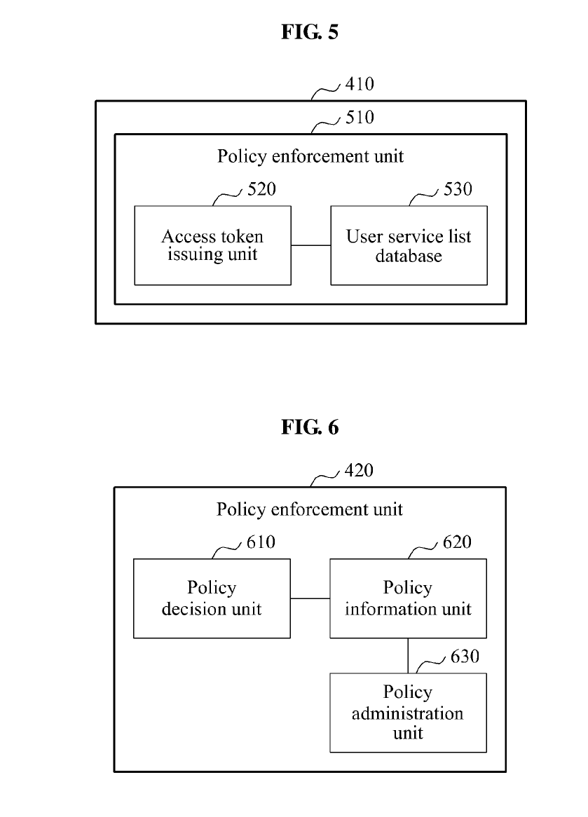

When a service requested by the user is not registered to a user service list database 530, the cloud service server 420 may request a policy administration unit 630 for the service. The user service list database 530 and the policy administration unit 630 will be further described with reference to FIG. 5 and FIG. 6.

The cloud service server 420 may compare user authentication information and user right information of the access token with an access control list of the cloud service server 420, a security policy of a policy information unit 620, and user role information of the policy information unit 620. The cloud service server 420 may approve an access of the user to the desired service based on the comparison result. The policy information unit 620 will be further described with reference to FIG. 6.

FIG. 5 is a block diagram illustrating a configuration of a collaborative service server according to an embodiment.

The collaborative service server 410 may include a policy enforcement unit 510. The policy enforcement unit 510 may be a PEP described above with reference to FIG. 1.

The policy enforcement unit 510 may include an access token issuing unit 520 and a user service list database 530.

The user service list database 530 may store right information of a user associated with a service subscribed to by the user and security policy information associated with the service.

The user service list database 530 may periodically update the right information and the security policy information. In response to a request for a new service from the user, the user service list database 530 may update the right information and the security policy information associated with the service subscribed to by the user.

The access token issuing unit 520 may perform credential verification (CV).

The access token issuing unit 520 may issue an access token of the service based on a service access request of the user, user authentication, and a service right. The access token may include information associated with the user authentication and the right information. When a request for an access to a service is received from the user, the access token issuing unit 520 may issue the access token based on the user authentication result provided from the cloud service server 420. The cloud service server 420 may receive, from the user service list database 530, right information associated with the service subscribed to by the user and security policy information associated with the service, an may use the right information and the security policy information in order to issue the access token.

FIG. 6 is a block diagram illustrating a configuration of a cloud service server according to an embodiment.

The cloud service server 420 may include a policy decision unit 610, the policy information unit 620, and the policy administration unit 630. The policy decision unit 610 may be a PDP described above with reference to FIG. 1, and the policy administration unit 630 may be a PAP described above with reference to FIG. 1.

The policy decision unit 610 may compare information associated with an access token with an access control list, a security policy of the policy information unit 620, and user right information of the policy information unit 620. The policy decision unit 610 may authorize an access of the user to the service when information associated with the access token satisfies or matches the access control list, the security policy, and the user right information as the comparison result.

The policy information unit 620 may store a security policy associated with the service. The policy information unit 620 may store user right information with respect to each service. In response to a request of the policy decision unit 610 for information such as the security policy or user right information, the policy information unit 610 may provide the requested information to the policy decision unit 610.

In response to a service request of the user, the policy administration unit 630 may set or correct a right of the user, a service policy, and a role. When the right of the user, the service policy, or the role is set or corrected, the policy administration unit 630 may transmit information associated with the set or corrected right of the user, service policy, or role to the user service list database 530 of the collaborative service server 410.

The policy administration unit 630 may provide user right information associated with the service, service policy information, and role information to the policy decision unit 610.

Each of service providers may manage the right of the user, the service policy, and the role. When information is additionally generated or corrected, each of the service providers may transmit the additionally generated or corrected information to the policy information unit 620. The additionally generated information may include the right of the user, the service policy, and the role. Based on the additionally generated or changed information, the policy information unit 620 may update the right of the user, the service policy, or the role.

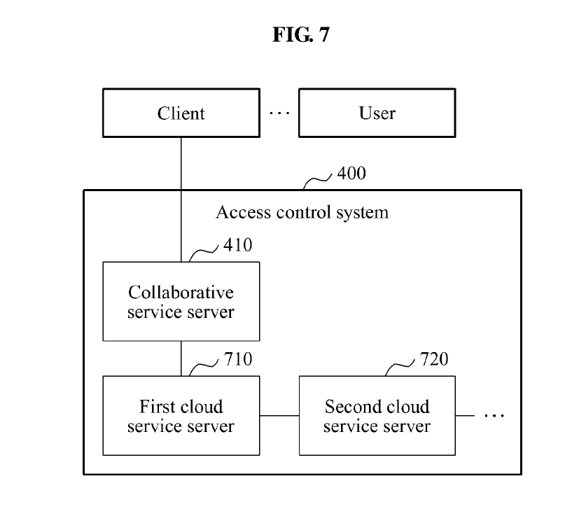

FIG. 7 is a block diagram illustrating an access control system in multiple cloud service servers according to an embodiment.

The multiple cloud service servers may provide a cloud computing service.

The access control system 400 of FIG. 4 may include a plurality of cloud service servers. For example, the number of cloud service servers 420 may be plural. Another configuration in addition to the above configuration may be included in the access control system 400.

The plurality of cloud service servers may be provided or operated by different cloud service providers, respectively.

In FIG. 7, a first cloud service server 710 and a second cloud service server 720 are provided as the plurality of cloud service servers.

Each of the first cloud service server 710 and the second cloud service server 720 may perform a function of the cloud service server 420 described above with reference to FIG. 4 through FIG. 6.

The technical description made above with reference to FIG. 1 through FIG. 6 may be applied as is and thus, a further detailed description will be omitted here.

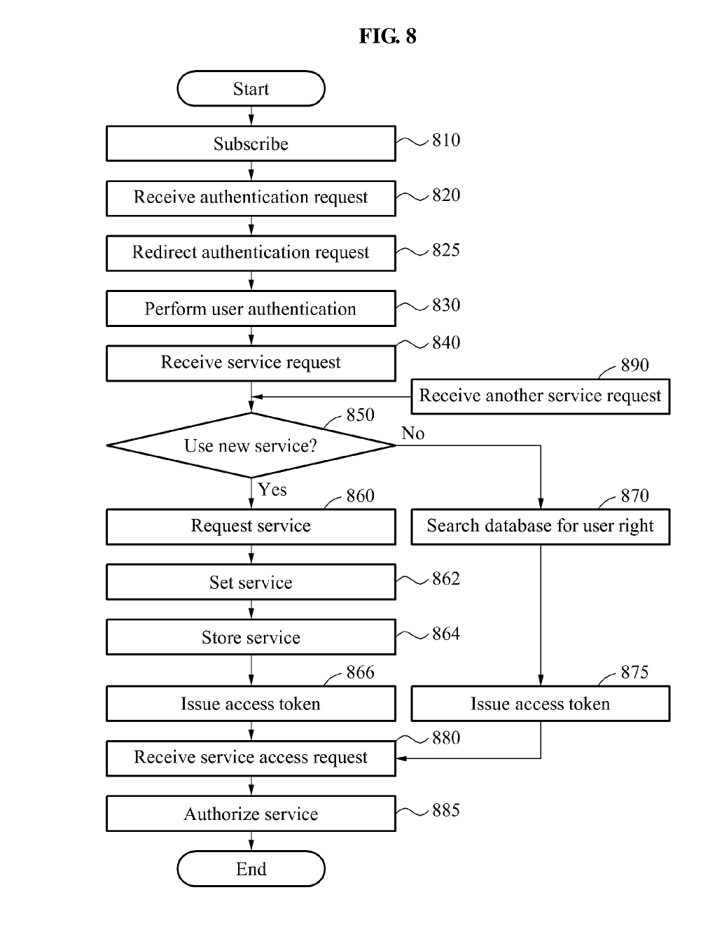

FIG. 8 is a flowchart illustrating an access control method of a single cloud service server according to an embodiment.

In operation 810, a user may subscribe to the cloud service server 420 in order to use a cloud computing service.

The user may enter a user ID, a user password, and user personal information into the cloud service server 420. The cloud service server 420 may receive the user ID, the user password, and the user personal information from a client, and may register the user using the received user ID, user password, and user personal information. The cloud service server 420 may issue an ID desired by the user to the user after user authentication.

In operation 820, the user may transmit a user authentication request to the collaborative service server 410. The collaborative service server 410 may receive an authentication request from a client used by the user.

In operation 825, the collaborative service server 410 enables the user authentication to be performed by the cloud service server 420 through redirection of the user authentication request. The collaborative service server 410 may redirect the user authentication request to the cloud service server 420.

In operation 830, the cloud service server 420 may perform the user authentication in response to the user authentication request received through the redirection.

The cloud service server 420 may encrypt user personal information and store the encrypted user personal information. The cloud service server 420 enables the user personal information to not remain in the cloud service server 420 through the encryption and storage.

After the user authentication, the user may transmit a service request for using a service desired by the user to the collaborative service server 410 in operation 840. The collaborative service server 410 may receive the service request from the client of the user.

In operation 850, the collaborative service server 410 may determine whether the service requested by the user is a new service. The collaborative service server 410 may determine whether the user is using the new service.

When the service requested by the user is not registered to the user service list to database 530, the collaborative service server 410 may determine that the service requested by the user is the new service. The user service list database 530 may include user authentication information, and may include information associated with the service requested by the user and a user ID.

When the user uses the new service, operation 860 may be performed. When the user uses an existing service, operation 870 may be performed.

In operation 860, the access token issuing unit 520 of the collaborative service server 410 may request the information administration unit 530 of the cloud service server 420 for the new service. The policy administration unit 630 may receive a request for the new service from the access token issuing unit 520.

In operation 862, the policy administration unit 630 may set the new service based on user authentication information. Here, setting of the new service may include setting at least one of a right to use the new service, a service range, a service security policy, and a service role with respect to the new service.

In operation 864, the policy administration unit 630 may store setting of the new service in the policy information unit 620.

Right information and security policy information registered to the policy information unit 620 may be stored in the user service list database 530.

In operation 866, the access token issuing unit 520 may generate an access token of the service based on the service access request of the user, user authentication, and a service right. The access token issuing unit 520 may generate the access token based on information associated with the user authentication, right information, and security policy information. The right information and the security information may be provided by the user service list database 530.

The access token issuing unit 520 may transmit the generated access token to the client of the user.

When the user uses the existing service, the collaborative service server 410 may search the user service list database 530 for right information associated with the service desired by the user in operation 870. When the existing service is used, existing right information and security policy information associated with the existing service may be used. For example, when the existing service is used, a right policy and a security policy do not change and thus, existing right information and security to policy information may be used.

In operation 875, the access token issuing unit 520 may generate the access token of the service based on the service access request of the user, the user authentication, and the service right. The access token issuing unit 520 may generate the access token based on information associated with the user authentication, right information, and security policy information. The right information and the security information may be provided by the user service list database 530.

The access token issuing unit 520 may transmit the generated access token to the client of the user.

In operation 880, the client of the user may request the cloud service server 420 for service access using the access token. The cloud service server 420 may receive the service access request from the client of the user. The service access request may include the access token. The service access request may be performed using the access token.

In operation 885, the policy decision unit 610 of the cloud service server 420 may compare right information provided by the policy information unit 620, security policy information provided by the policy information unit 620, and a user access control list of the access control list with user authentication information of the access token, right information of the access token, and security policy information of the access token. The policy decision unit 610 may authorize an access of the user to the service when right information provided by the policy information unit 620, security policy information provided by the policy information unit 620, and a user access control list of the access control list matches user authentication information of the access token, right information of the access token, and security policy information of the access token as the comparison result.

After the above authentication, the user may call the service and may use the service in a collaborative service environment.

In operation 890, the user may desire to use another service or a service provided by another cloud service provider while using the service. The collaborative service server 410 may receive another service request from the client of the user.

The access token issuing unit 520 of the collaborative service server 410 may request the information administration unit 630 of the cloud service server 420 to providing another service for using the other service. For example, the request for the other service may be transmitted to the policy administration unit 630 of the cloud service server 420 through the access token issuing unit 520 of the collaborative service server 410.

When the request for using the other service is received, new right information and security policy information may be updated in an access token of the cloud service server 420 corresponding to the other service. Using the access token with the updated new right information and security policy information, the user may use the other service.

The technical description made above with reference to FIG. 1 through FIG. 7 may be applied as is and thus, a further detailed description will be omitted here.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave to capable of providing instructions or data to or being interpreted by the processing device. The software also may be distributed over network coupled computer systems so that the software is stored and executed in a distributed fashion. In particular, the software and data may be stored by one or more computer readable recording mediums.

The embodiments may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

1. A collaborative service server of a cloud computing service, comprising:
a user service list database to store right information of a user associated with a service subscribed to by the user and security policy information associated with the service; and
an access token issuing unit to issue an access token of the service based on a service access request of the user, user authentication, and a service right.

2. The collaborative service server of claim 1, wherein the collaborative service server performs the user authentication through a cloud service server.

3. The collaborative service server of claim 2, wherein the access token issuing unit issues the access token based on a result of the user authentication provided from the cloud service server.

4. The collaborative service server of claim 2, wherein the user service list database provides the right information and the security policy information to the cloud service server.

5. The collaborative service server of claim 1, wherein the access token comprises information associated with the user authentication and the right information.

6. The collaborative service server of claim 1, wherein the user service list database periodically updates the right information and the security policy information.

7. The collaborative service server of claim 1, wherein, in response to a request for a new service from the user, the user service list database updates the right information and the security policy information associated with the service subscribed to by the user.

8. A cloud service server, comprising:
a policy information unit to store a security policy associated with a service accessed by a user and user right information associated with the service; and
a policy decision unit to compare information associated with an access token with an access control list, the security policy, and the user right information, and to authorize an access of the user to the service when information associated with the access token matches the access control list, the security policy, and the user right information as the comparison result.

9. The cloud service server of claim 8, further comprising:
a policy administration unit to set or correct a right of the user, a service policy, and a role.

10. The cloud service server of claim 9, wherein when the right of the user, the service policy, or the role is set or corrected, the policy administration unit transmits information associated with the set or corrected right of the user, service policy, or role to the collaborative service server.

11. A method of providing a collaborative service in a cloud computing service, the method comprising:
storing, by a user service list database, right information of a user associated with a service subscribed to by the user and security policy information associated with the service; and
issuing, by an access token issuing unit, an access token of the service based on a service access request of the user, user authentication, and a service right.

12. The method of claim 11, further comprising:
performing the user authentication through a cloud service server.

13. The method of claim 12, wherein the issuing comprises issuing the access token based on a result of the user authentication provided from the cloud service server.

14. The method of claim 12, wherein the storing comprises providing the right information and the security policy information to the cloud service server.

15. The method of claim 11, wherein the access token comprises information associated with the user authentication and the right information.

16. The method of claim 11, wherein the user service list database periodically updates the right information and the security policy information.

17. The method of claim 11, wherein, in response to a request for a new service from the user, the user service list database updates the right information and the security policy information associated with the service subscribed to by the user.

18. A method of providing a cloud service, the method comprising:
storing, by a policy information unit, a security policy associated with a service accessed by a user and user right information associated with the service; and
comparing, by a policy decision unit, information associated with an access token with an access control list, the security policy, and the user right information, to authorize an access of the user to the service when information associated with the access token matches the access control list, the security policy, and the user right information as the comparison result.

19. The method of claim 18, further comprising:
setting or correcting, by a policy administration unit, a right of the user, a service policy and a role.

20. The method of claim 19, further comprising:
transmitting, by the policy administration unit, information associated with the set or corrected right of the user, service policy, or role to the collaborative service server when the right of the user, the service policy, or the role is set or corrected.
